(19) United States
(12) Patent Application Publication
(10) Pub. No.: US 2024/0347692 A1
(43) Pub. Date: Oct. 17, 2024

(54) PASTE-TYPE ELECTRODE FOR PROTON CONDUCTIVE SECONDARY BATTERY AND PROTON CONDUCTIVE SECONDARY BATTERY PROVIDED WITH SAME

(71) Applicant: KAWASAKI MOTORS, LTD., Hyogo (JP)

(72) Inventors: Kwohsiung YOUNG, Hyogo (JP); Taihei OUCHI, Hyogo (JP); Hiroshi FUKUNAGA, Hyogo (JP)

(73) Assignee: KAWASAKI MOTORS, LTD., Hyogo (JP)

(21) Appl. No.: 18/294,740

(22) PCT Filed: Aug. 5, 2021
(86) PCT No.: PCT/JP2021/029209

§ 371 Date: Feb. 2, 2024

(51) Int. Cl. H01M 4/134; H01M 4/02; H01M 4/38; H01M 4/62

(52) U.S. Cl. CPC H01M 4/134; H01M 4/386; H01M 4/622; H01M 4/625; H01M 2004/027

(57) ABSTRACT

A paste electrode for use as an anode of a proton conductive secondary battery includes: an active material powder containing a group 14 element as a predominant component; a binder; and a substrate with a mixture applied thereon, the mixture containing the active material powder and the binder. The mixture may contain one or more conductive additives. The active material powder may contain silicon as the group 14 element.

### BACKGROUND OF THE INVENTION

### Field of the Invention

The present invention relates to a paste electrode for a proton conductive secondary battery as well as to a proton conductive secondary battery including the same.

### Description of Related Art

Alkali metals with low electrochemical equivalents, such as lithium, are particularly useful as constituent material for batteries. Use of lithium makes it possible to increase energy per unit mass as compared with nickel or cadmium, which have been used conventionally. In the development of rechargeable lithium metal batteries, however, effective charge/discharge cycling remains an important development challenge. Repeated charging and discharging result in gradual formation of lithium “dendrites” on the surface of the lithium metal electrode. Such dendrites can grow and eventually reach the cathode, causing an internal short circuit in a battery. In such a case, the battery may become unusable after relatively few cycles.

As such, a candidate alternative technology for secondary batteries is to cycle hydrogen atoms, which have an extremely low molecular weight. It has been known that some materials of metal hydride alloys such as nickel hydroxide can absorb and desorb hydrogen. Such hydrogen storage materials can be used as cathode materials in combination with appropriate anode materials and non-aqueous electrolytes such as ionic liquids to provide proton conductive secondary batteries (see, e.g., Patent Document 1). As an anode material, for example, silicon is promising because silicon has an extremely high theoretical specific capacity.

### RELATED DOCUMENT

### Patent Document

[Patent Document 1] U.S. Pat. No. 5,536,591

### SUMMARY OF THE INVENTION

Currently, silicon-based anodes are generally produced by dry compression molding of an active material mixture containing a conductive binder. In dry compression molding process, however, it is difficult to adjust the thickness of the electrode to a predetermined value. Furthermore, dry compression molding process produces a large amount of processing waste during the manufacturing, and processing waste may cause an internal short circuit when it adheres to the electrode surface. Therefore, dry compression molding process is not suitable for mass production of proton conductive secondary batteries. In addition, dry compression process cannot be used when a metal foil is used as a substrate on which the active material is fixed or when the electrode material contains a flammable material.

In order to solve the problems, an object of the present disclosure is to provide an anode that is suitable to mass production of proton conductive secondary batteries and is applicable to various types of proton conductive secondary batteries.

In order to achieve the object, the present disclosure provides a paste electrode for a proton conductive secondary battery, which is a paste electrode for use as an anode of a proton conductive secondary battery, the paste electrode including:
an active material powder containing a group 14 element as a predominant component;
a binder; and
a substrate with a mixture applied thereon, the mixture containing the active material powder and the binder.

A paste electrode according to this configuration, which is produced using a wet-laid process, can be easily tailored to have a thickness of a predetermined value and can be produced with a reduced amount of machining waste in manufacturing process, thereby facilitating mass production of proton conductive secondary batteries including such a paste electrode. In addition, it was confirmed that regardless of including an anode in the form of a paste electrode, a proton-type secondary battery can exhibit satisfactory charge/discharge performance for practical use, as will be described later in detail.

The present disclosure provides a proton conductive secondary battery including:
an anode including the above-described paste electrode;
a cathode including a cathode active material capable of absorbing and desorbing hydrogen; and
a non-aqueous electrolyte between the cathode and the anode.

The present disclosure encompasses any combination of at least two features disclosed in the claims and/or the specification and/or the drawings. In particular, any combination of two or more of the appended claims should be equally construed as included within the scope of the present disclosure.

### BRIEF DESCRIPTION OF THE DRAWINGS

The present disclosure will be more clearly understood from the following description of preferred embodiments thereof, when taken in conjunction with the accompanying drawings. However, the embodiments and the drawings are given only for the purpose of illustration and explanation, and are not to be taken as limiting the scope of the present disclosure in any way whatsoever, which scope is to be determined by the appended claims. In the accompanying drawings, like reference numerals are used to denote like or corresponding parts throughout the several views. In the figures,

FIG. 1 is a sectional view that schematically shows a test cell for testing characteristics of an anode according to one embodiment of the present disclosure;

FIG. 2 is a graph that shows the test results of charge/discharge cycles of a test cell including an anode according to one embodiment of the present disclosure; and

FIG. 3 is a graph that shows the test results of charge/discharge cycles of a test cell including an anode according to another embodiment of the present disclosure.

### DESCRIPTION OF THE EMBODIMENTS

Hereinafter, an embodiment according to the present disclosure is described with reference to the drawings. The present disclosure, however, is not limited to this embodiment.

An electrode for a proton conductive secondary battery according to the instant embodiment is a paste electrode for use as an anode of a proton conductive secondary battery, the paste electrode including: an active material powder containing a group 14 element as a predominant component; a binder; and a substrate with a mixture applied thereon, the mixture containing the active material powder and the binder. The paste electrode is prepared using a wet-laid process, so that the thickness of the electrode can be easily adjusted to a predetermined value, and generation of machining waste can be suppressed in manufacturing process. Thus, mass production of proton conductive secondary batteries including this paste electrode can be facilitated. In addition, it was confirmed that regardless of including an anode in the form of a paste electrode, the battery can achieve adequate charge/discharge performance for practical use as a proton type secondary battery, as will be described later in detail.

A proton conductive secondary battery according to the instant embodiment includes, in addition to the anode as described above, a cathode including a cathode active material capable of absorbing and desorbing hydrogen, and a non-aqueous electrolyte between the cathode and the anode. The proton conductive secondary battery further includes a separator which is interposed between the anode and the cathode and transmits protons.

A proton conductive secondary battery according to the instant embodiment includes a cathode including a cathode active material capable of absorbing and desorbing hydrogen, an anode including an anode active material capable of absorbing and desorbing hydrogen, and an electrolyte formed of a compound or compounds that is/are mentioned above as illustrative examples.

The “proton conductive secondary battery” used herein differs from a conventional battery with metal hydrides in many respects, such as not using an aqueous electrolyte. This new type of proton conductive secondary battery operates by cycling hydrogen between the anode and the cathode as with a conventional battery. The anodes thereby form a hydride of one or more elements in the anode during charge. This hydride is formed reversibly such that during discharge the hydride becomes the elemental portion of the anode active material generating both a proton and an electron.

As used herein, an “anode” refers to an electrode that includes a material that electrochemically accepts electrons during charge, and a “cathode” refers to an electrode that includes a material that electrochemically donates electrons during charge.

The half reaction that takes place at the anode of the proton conductive secondary battery can be described per the following half reaction:

M+H⁺+ₑ⁻⇄MH [Chem 1]
where M as provided herein is an anode active material and will be described later.

The cathode reaction half corresponding to the aforementioned reaction can be described per the following half reaction:

M_{c}(OH)₂⇄McOOH+H⁺+e⁻ [Chem 2]

where M_{c} as provided herein is a metal element in a cathode active material M_{c}(OH)₂.

The cathode active material is, for example, a hydroxide of a transition metal. In particular, for example, the cathode active material may be a nickel hydroxide or a nickel-containing complex hydroxide which contains nickel and other transition metal(s). More specifically, for example, the cathode active material may be a compound represented by Ni_{(1-x-y)}CoₓZn_{y}(OH)₂ (where 0≤x≤0.1, 0≤y≤0.1).

The anode active material is a group 14 element, which is capable of absorbing hydrogen electrochemically generated in an electrolyte during charge and readily desorbing the stored hydrogen during discharge, or a compound or an alloy containing a plurality of group 14 elements. Specific examples of the anode active material may include silicon, carbon, silicon carbide (CₓSi₁₋ₓ), and a silicon-germanium alloy (SiₓGe₁₋ₓ).

The anode active material preferably includes silicon alone, or a silicon-containing compound, or a combination thereof in that high charge/discharge capacity can be achieved. The weight percent of the element silicon in the anode active material is not limited to a specific value and may be 80% by weight (wt %) or greater, 85 wt % or greater, and even 90 wt % or greater.

The crystalline state of an anode active material is not limited to a specific one and may be any of monocrystalline, polycrystalline, nanocrystalline (microcrystalline), and amorphous, or any combination of the foregoing.

An anode active material, a cathode active material, or both may be in a powder or particulate form. The particles may be held together by a binder to form a layer on a current collector in the formation of the anode or cathode. A binder suitable for use in forming an anode, a cathode or both is optionally any binder known in the art suitable for such purposes and for the conduction of a proton.

Illustratively, a binder for use in the formation of an anode includes but is not limited to polymeric binder materials. Specific examples of a binder material include an elastomeric material, and more specifically, for instance, styrene-butadiene (SB), styrene-butadiene-styrene block copolymer (SBS), styrene-isoprene-styrene block copolymer (SIS) and styrene-ethylene-butadiene-styrene block copolymer (SEBS). Illustrative specific examples of a binder include, but are not limited to polytetrafluoroethylene (PTFE), polyvinyl alcohol (PVA), teflonized (trademark) acetylene black (TAB-2), styrene-butadiene binder materials, or carboxymethyl cellulose (CMC).

A cathode, an anode or both may further include one or more additives intermixed with the active materials. For instance, an additive is a conductive material. A conductive material is preferably a conductive carbon. Illustrative examples of a conductive carbon include graphite, carbon nanotubes, graphitic carbons such as graphitized cokes. Still other examples of a conductive carbon include non-graphitic carbons that may be amorphous, non-crystalline, and disordered, such as petroleum cokes and carbon black. A conductive material is present in a cathode or an anode at a weight percent (wt %) of, for example, from 0.1 wt % to 20 wt %.

In this embodiment, an anode is a paste electrode as discussed above. That is, an anode active material may be combined with a binder, and optionally conductive material, in an appropriate solvent to form a paste-like mixture (slurry). The slurry may be coated onto a current collector (substrate) and dried to evaporate some or all of the solvent to thereby form a layer of the active material on the current collector.

A cathode may be formed by any method known in the art. For example, as with an anode, a cathode active material may be combined with a binder, and optionally conductive material, in an appropriate solvent to form a slurry. The slurry may be coated onto a current collector and dried to evaporate some or all of the solvent to thereby form a layer of the active material on the current collector.

A current collector may be in the form of a mesh, a foil, or any other suitable shape. For instance, a current collector may be formed of aluminum-based metal such as an aluminum alloy, nickel or nickel alloy, steel such as stainless steel, copper or copper alloys, or other such material. For example, a current collector may be in the form of a sheet, and may be in the form of a foil, solid substrate, porous substrate, grid, foam, or other form known in the art. A current collector may be any material that has suitable electron conductivity and is selectively nonpermeable or substantially nonpermeable. Illustrative examples may include copper, stainless steel, titanium, or carbon paper/film, non-perforated metallic foil, aluminum foil, clad material containing nickel and aluminum, clad material containing copper and aluminum, nickel-plated steel, nickel-plated copper, nickel-plated aluminum, gold, silver, or any suitable combination thereof.

A non-aqueous electrolyte contains, for example, an ionic liquid. Such an ionic liquid contained in an electrolyte may contain, for example, an aprotic liquid and one or more acids as a proton source added to the aprotic liquid. An aprotic liquid may any compound that is suitable for a composition in an electrolyte and cannot cause any detrimental reaction in combination with any other compounds in a battery. Illustrative examples of a compound for an aprotic liquid may include an ammonium or phosphonium compound, and optionally, the ammonium or phosphonium contains one or more linear, branched, or cyclic substituted or non-substituted alkyls bonded to nitrogen or phosphorus.

An aprotic compound may be, for example, an ammonium or phosphonium compound containing one or more linear, or branched, or cyclic substituted or non-substituted alkyls bonded to a positively-charged nitrogen or phosphorus atom. Nitrogen or phosphorus may be a constituent element of five- or six-membered ring structure which may include one or more pendant groups extending from the center ring. As a specific example, an ammonium ion may be an imidazolium ion, and a phosphonium ion may be a pyrrolidinium ion.

Ammonium or phosphonium contains one or two linear or cyclic, substituted or non-substituted alkyls having 1 to 6 carbon atoms. Optionally, an allyl has 2 to 6 carbon atoms. Substituting element in an alkyl may be, for example, nitrogen, oxygen, or sulfur.

Illustrative specific examples of an aprotic compound for an electrolyte may include, but are not limited to 1-butyl-3-methylimidazolium (BMIM), 1-ethyl-3-methylimidazolium (EMIM), 1,3-dimethylimdiazolium, 1,2,3-trimethylimidazolium, tris-(hydroxyethyl)methylammonium, 1,2,4-trimethylpyrazolium, or combinations thereof.

An aprotic compound contains one or more anions in combination with an aprotic compound as needed. Illustrative examples of an anion may include, but are not limited to methides, nitrates, carboxylates, imides, halides, borates, phosphates, phosphinates, phosphonates, sulfonates, sulfates, carbonates, and aluminates. More specific examples of an anion may include carboxylates such as acetates, hydrogen, alkyls, or phosphates such as fluorophosphates, phosphinates such as alkyl phosphinates. Examples of such aprotic compounds may include, but are not limited to those that include acetates, sulfonates, or borates of 1-butyl-3-methylimidazolium (BMIM), 1-ethyl-3-methylimidazolium (EMIM), 1,3-dimethylimidazolium, 1,2,3-trimethylimidazolium, tris-(hydroxyethyl)methylammonium, 1,2,4-trimethylpyrazolium, or combinations thereof. Specific examples of such compounds may include diethylmethylammonium trifluoromethanesulfonate (DEMA/TfO), 1-ethyl-3-methylimidazolium acetate (EMIM/AC) or 1-butyl-3-methylimidazolium bis(trifluoromethylsulfonyl)imide (BMIM/TFSI).

As needed, a pH buffer in the form of a salt may be added to an ionic liquid of an electrolyte. A salt to be added may be an organic or inorganic salt. Examples of organic salts may include, but are not limited to potassium or sodium citrates, and potassium or sodium oxalates. Examples of inorganic salts may include, but are not limited to phosphates, carbonates, or sulfates of potassium or sodium. These salt additives may have an acid dissociation constant (pKa) in the range of from 1 to 14 in an aqueous solution. A salt may have a pKa value lower than 7, even lower than 3, and even lower than 1.5.

A proton conductive secondary battery may include a separator interposed between the anode and the cathode. A separator used may have hydrogen permeability such that the separator can permit or does not unacceptably restrict transport of ions between the anode and the cathode. Illustrative examples of separator material may include, but not limited to nylon, polyester, polyvinyl chloride, glass fibers, and cotton. To give more specific examples, a separator may be made of polyethylene or polypropylene.

A separator may be a proton exchange membrane that selectively conducts protons only. The proton exchange membrane may be a proton conductive (proton permeable) polymeric material. More specifically, examples of a proton exchange membrane may include perfluorosulfonic acid membranes (PFSA), PFSA-PTFE composites, sulfonated polysulfones, sulfonated hydrocarbons, sulfonated polyetheretherketones (s-PEEK), sulfonated polyimides, sulfonated polyetherimides, sulfonated poly(2,6-dimethyl-1,4-phenylene ether), composite membranes (PFSA-silica), sulfonated polystyrenes, sulphonated phenylated polyphenylenes, sulphonated poly(arylene sulphone), sulphonated poly(arylene ether ketone), poly(arylene ether ketone), poly(arylene sulphone), poly(benzimidazole), and poly(para-phenylene). Such materials are commercially available, for example, from IONOMR, Inc., Vancouver, Canada.

An anode, a cathode, a separator, and an ionic liquid used as an electrolyte are housed in a housing. The housing may be in the form of, for example, a metal or polymeric can, or may be a laminate film, such as a heat-sealable aluminum foil, such as an aluminum coated polypropylene film. As such, an electrochemical battery as provided herein may be in any known form, illustratively, a button cell, pouch cell, cylindrical cell, or square cell.

A current collector and/or substrate may include one or more tabs to allow the transfer of electrons from the current collector to a region exterior of the cell and to connect the current collector(s) to a device such as a circuit. A tab may be formed of any suitable conductive material (e.g. Ni, Al, or other metal) and may be connected, e.g., welded, onto the current collector.

The present disclosure is more specifically described with reference to the following examples. However, the present disclosure is not limited to these examples.

### EXAMPLES

### (Production of Test Batteries)

As a cathode, a paste-type electrode having a size of 14 mm×23 mm (0.54 mm thick) was produced using an active material containing Ni(OH)₂ as a predominant component.

As an anode according to Example 1 (hereinafter, referred to as an “Example 1 anode”), used was a mixture containing silicon powder (available from Japan Natural Energy & Resources Co., Ltd.) as an active material, carbon nanotube (available from FUJIFILM Wako Pure Chemical Corporation) as a conductive material, and polyethylene oxide (available from Meisei Chemical Industry Co., Ltd.) as a binder at a ratio of 22:65:13. The anode had a size of 10 mm×15 mm (0.092 mm thick). The test battery was configured as anode capacity limited.

Then, production process of an Example 1 anode is described in detail. Silicon polycrystalline powder was used for silicon as an active material. The silicon powder and carbon nanotube were placed into a beaker and agitated several times. A polyethylene oxide solution and an appropriate amount of ethanol were added to the mixed powder, and the mixture was stirred at room temperature for 1 hour using a stirrer. Thereby, a paste-like anode mixture was prepared. A nickel foam (available from Sumitomo Electric Industries, Ltd.) having a thickness of 0.2 mm and a weight density of 400 g/m³ was provided as a substrate. The paste-like anode mixture was applied to this substrate to impregnate it, and the paste that spread beyond the substrate was scraped off. The electrode in this state was dried in a dryer at 70° C. for 20 minutes. The dried electrode body was compressed at 40 MPa using a hydraulic press to obtain a final Example 1 anode for a test battery. The final electrode had a thickness of from 0.15 to 0.18 mm.

EMIM/AC (purity >95%) containing 3.33 mol acetic acid was used as an electrolyte. A sulfonated polyethylene/polypropylene membrane (available from JAPAN VILENE COMPANY, LTD.) having a thickness of 210 μm was used as a separator.

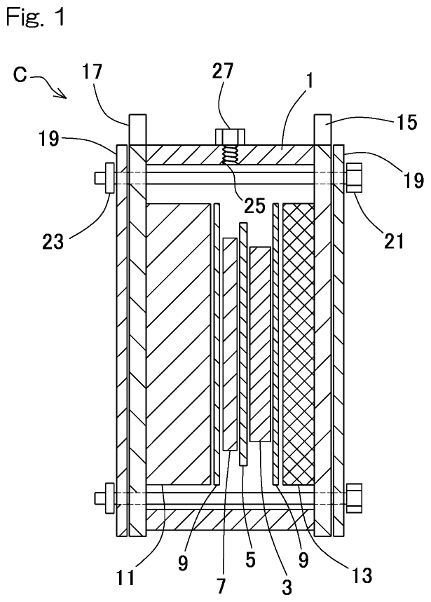

An electrochemical cell was prepared for testing the electrochemical properties of the above-mentioned Example 1 anode. FIG. 1 shows the structure of a test cell C used in this charge/discharge test. The test cell C had a frame 1 made of polypropylene, and an electrode group including a cathode 3, a separator 5, and an anode 7 was placed inside the frame 1 with the electrode group held between Ni plates 9, a Ni block 11, and a Ni foam 13 (cushion material). The frame 1 was covered with a cathode terminal plate 15 and an anode terminal plate 17, which were in turn covered with insulating plates 19 made of polypropylene. The plates were fixed with hexagonal screws 21 and nuts 23. The electrolyte was poured in from a screw hole 25 at the top, and a hexagonal screw 27 was fastened to form a closed test cell C. Hereinafter, a test cell including an Example 1 anode is referred to as a “first test cell”.

### (Charge and Discharge Condition)

The first test cell was supplied to a charge/discharge cycle test with the following charge and discharge condition. As for discharging, multi-stage discharging was carried out in which the discharge rate was gradually reduced.

### [First Cycle]

Charge: charge rate of 150 mAh/g×80 hours (h)
Rest: 1 minute (min)
Discharge: discharge rate of 150 mAh/g; cutoff voltage of 0 Volt (V)
Rest: 1 min
Discharge: discharge rate of 75 mAh/g; cutoff voltage of 0 V
Rest: 1 min
Discharge: discharge rate of 30 mAh/g; cutoff voltage of 0 V
Rest: 1 min
Discharge: discharge rate of 15 mAh/g; cutoff voltage of 0 V
Rest: 1 min

### [Second and Subsequent Cycles]

Charge: charge rate of 150 mAh/g×20 h
Rest: 1 min
Discharge: discharge rate of 150 mAh/g; cutoff voltage of 0 V
Rest: 1 min
Discharge: discharge rate of 75 mAh/g; cutoff voltage of 0 V
Rest: 1 min
Discharge: discharge rate of 30 mAh/g; cutoff voltage of 0 V
Rest: 1 min
Discharge: discharge rate of 15 mAh/g; cutoff voltage of 0 V
Rest: 1 min

It should be noted that the charge and discharge rates indicated above are values per mass (g) of an anode active material (silicon).

### (Test Results)

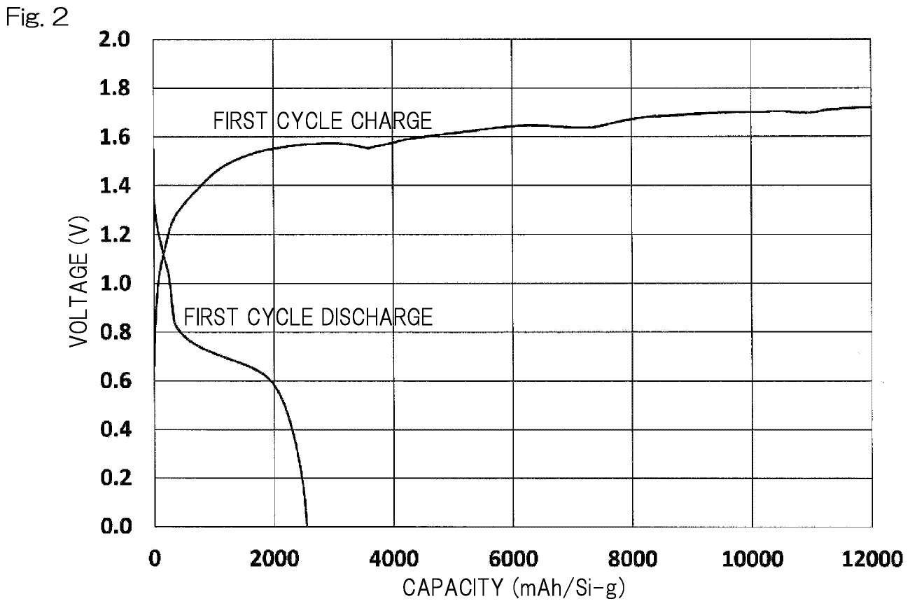

FIG. 2 and Table 1 below show the results of the test performed with the condition as set out above.

TABLE 1

| | First Cycle | Second Cycle |
|---|---|---|
| Discharge Current | Discharge | Discharge |
| Density (mA/g) | Capacity (mAh/g) | Capacity (mAh/g) |
| 150 | 2544 | 1608 |
| 75 | 65 | 86 |
| 30 | 56 | 102 |
| 15 | 35 | 42 |
| Total | 2700 | 1838 |

In the first cycle, the discharge capacity was 2700 mAh with respect to the charge capacity of 12000 mAh, giving a Coulombic efficiency of 23%. In the second cycle, the discharge capacity was 1838 mAh with respect to the charge capacity of 3000 mAh, giving an increased Coulombic efficiency of 61%. As indicated by the test results, it was confirmed that the proton absorption-desorption reaction was repeated without any problem in the paste-type anode in which polycrystalline silicon was used as the active material.

Next, an anode according to Example 2 (hereinafter, referred to as an “Example 2 anode”) was produced in the same procedure as that for the Example 1 anode, except for using 1.0 g of amorphous silicon powder (available from Cenate, Norway) for silicon powder as an active material. A test cell was produced in the same manner as described above, except for using an Example 2 anode as an anode. This test cell is referred to as a “second test cell”.

### (Charge and Discharge Condition)

The second test cell was supplied to a charge/discharge cycle test with the following charge and discharge condition. As for discharging, multi-stage discharging was carried out in which the discharge rate was gradually reduced. It should be noted that the following charge and discharge condition is the same as the above-described charge and discharge condition for the first test cell, except for the charge condition in the first cycle.

### [First Cycle]

Charge: charge rate of 600 mAh/g×20 h
Rest: 1 min
Discharge: discharge rate of 150 mAh/g; cutoff voltage of 0V
Rest: 1 min
Discharge: discharge rate of 75 mAh/g; cutoff voltage of 0V
Rest: 1 min
Discharge: discharge rate of 30 mAh/g; cutoff voltage of 0V
Rest: 1 min
Discharge: discharge rate of 15 mAh/g; cutoff voltage of 0V
Rest: 1 min

### [Second and Subsequent Cycles]

Charge: charge rate of 150 mAh/g×20 h
Rest: 1 min
Discharge: discharge rate of 150 mAh/g; cutoff voltage of 0V
Rest: 1 min
Discharge: discharge rate of 75 mAh/g; cutoff voltage of 0V
Rest: 1 min
Discharge: discharge rate of 30 mAh/g; cutoff voltage of 0V
Rest: 1 min
Discharge: discharge rate of 15 mAh/g; cutoff voltage of 0V
Rest: 1 min

### (Test Results)

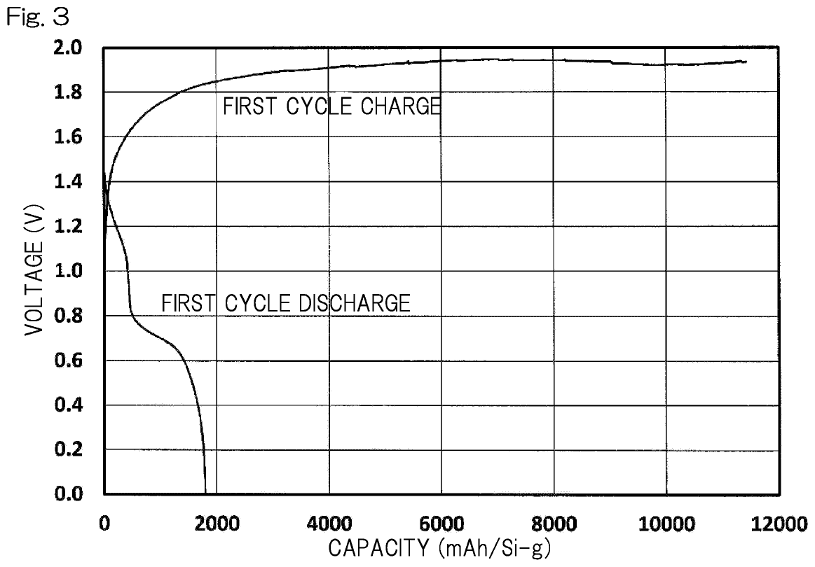

FIG. 3 and Table 2 below show the results of the test performed with the condition as set out above.

TABLE 2

| | First Cycle | Second Cycle |
|---|---|---|
| Discharge Current | Discharge | Discharge |
| Density (mA/g) | Capacity (mAh/g) | Capacity (mAh/g) |
| 150 | 1796 | 1293 |
| 75 | 107 | 25 |
| 30 | 158 | 58 |
| 15 | 59 | 60 |
| Total | 2120 | 1436 |

In the first cycle, the discharge capacity was 2120 mAh with respect to the charge capacity of 12000 mAh, giving a Coulombic efficiency of 18%. In the second cycle, the discharge capacity was 1436 mAh with respect to the charge capacity of 3000 mAh, giving an increased Coulombic efficiency of 61%. As indicated by the test results, it was confirmed that the proton absorption-desorption reaction was repeated without any problem in the paste-type anode in which amorphous silicon was used as the active material.

As seen above, the paste electrode, which is produced using a wet-laid process, can exhibit satisfactory charge/discharge performance in practical use, can be easily tailored to have an electrode thickness of a predetermined value, and can be produced with a reduced amount of machining waste in manufacturing process. Therefore, the paste electrode facilitates mass production of proton conductive secondary batteries including the same.

Although the present disclosure has been described in terms of the preferred embodiments thereof with reference to the drawings, various additions, modifications, or omissions may be made without departing from the scope of the invention. Accordingly, such variants are included within the scope of the present disclosure.

1. A paste electrode for use as an anode of a proton conductive secondary battery, the paste electrode comprising:
an active material powder containing a group 14 element as a predominant component;
a binder; and
a substrate with a mixture applied thereon, the mixture containing the active material powder and the binder.

2. The paste electrode as claimed in claim 1, wherein the mixture contains one or more conductive additives.

3. The paste electrode as claimed in claim 2, wherein the one or more conductive additives contain a carbon material.

4. The paste electrode as claimed in claim 3, wherein the carbon material comprises one or a combination selected from graphite, carbon black, and carbon nanotube.

5. The paste electrode as claimed in claim 1, wherein the active material powder contains silicon as the group 14 element.

6. The paste electrode as claimed in claim 5, wherein the content of silicon in the active material powder is 80% or more by weight.

7. The paste electrode as claimed in claim 1, wherein the active material powder comprises one or a combination selected from polycrystalline particles, nanocrystalline particles, and amorphous particles.

8. A proton conductive secondary battery comprising:
an anode including the paste electrode as claimed in claim 1;
a cathode including a cathode active material capable of absorbing and desorbing hydrogen; and
a non-aqueous electrolyte between the cathode and the anode.
